(19) United States
(12) Patent Application Publication
(10) Pub. No.: US 2008/0099077 A1
(43) Pub. Date: May 1, 2008

(54) LEAKPROOF TAPPING TEE ASSEMBLY

(75) Inventor: Jason R. Knaus, Painesville, OH (US)

Correspondence Address: FAY SHARPE LLP, 1100 SUPERIOR AVENUE, SEVENTH FLOOR, CLEVELAND, OH, 44114, US

(73) Assignee: Perfection Corporation, Madison, OH (US)

(21) Appl. No.: 11/877,659

(22) Filed: Oct. 23, 2007

Related U.S. Application Data
(60) Provisional application No. 60/854,991, filed on Oct. 27, 2006.

(51) Int. Cl. F16L 47/34

(52) U.S. Cl. 137/317

(57) ABSTRACT

A mechanical tapping tee assembly and a method for fluidly connecting to a conduit include a body defining a conduit recess for receiving the conduit and further defining a main passage having one end adjacent the conduit recess. A plug is disposed in the main passage preventing fluid communication between at least a portion of the main passage and the conduit recess. A cutter received in the main passage and threadedly engaged with a threaded region of the main passage is selectively advanced and retracted within the main passage upon rotation relative to the body. The cutter includes a cutting edge that taps the plug to fluidly connect the conduit recess and said at least a portion of the main passage and to tap the conduit to fluidly connect the conduit and the main passage.

Applicant claims priority to U.S. Provisional Application No. 60/854,991, filed Oct. 27, 2006, and hereby incorporates that application by reference herein.

### BACKGROUND

The present disclosure generally relates to the art of tapping conduits, pipes or tube-like workpieces and more particularly to tapping an existing conduit for connection with another conduit. In one embodiment, a leakproof tapping tee assembly and method are provided for tapping into an existing plastic conduit (e.g., a gas main or a water main) to establish fluid communication between the plastic conduit and another, secondary conduit. Though the present disclosure will describe the afore-described embodiment in particular detail, it is to be appreciated that the subject matter described herein has broader applications and may be advantageously employed in related environments and applications.

Polymer and plastic piping has become ubiquitous in many industries and is used within many varying types of pipeline networks. For example, such piping is commonly employed throughout the United States in gas pipeline networks for delivering pressurized gas (e.g., natural gas) to homes and businesses. In Europe, such piping is commonly employed in water pipeline networks for delivering water to homes and businesses. More recently, there has also been an increased interest in the use of such piping in European gas pipeline networks. Whether for water or gas, or some other fluid or substance, the pipeline network employing polymer and/or plastic piping typically includes pipe mains, which are often buried, for conveying the carried fluid (e.g., water or gas) to various locations and service lines, which interconnect a home or business with a selected pipe main.

In particular, the pipe main is often an existing or previously installed main that continuously carries a fluid (i.e., a live main), the shutting down of which is highly discouraged and inconvenient. Tapping tees are frequently and advantageously used for connecting secondary conduits, such as service lines, to pipe mains, particularly when the secondary conduit is to be installed to a live main. A tapping tee can incorporate a drill-like or cutting toot with a mounting collar for allowing the tee to be positioned at any desired location along the main. Typically, the tee is first attached to the main by using a split collar arrangement or, alternately, the tee may be fused to the main. Thereafter, the cutting tool is advanced through the sidewall of the main to open a fluid passage between the main and the tapping tee. The tapping tee often includes appropriate structure for more easily and conveniently connecting to the secondary conduit, wherein such connection is often completed prior to tapping the main (i.e., advancing the cutting tool to establish fluid communication). One advantage of such a tapping tee is that it is not necessary to actually sever the entire main, or otherwise interrupt service provided through the main, in order to interconnect the tee. Rather, the tapping tee requires only that a hole be drilled into the main in order to provide for fluid communication therewith.

Tapping tees that are fused to the main, sometimes referred to as electrofusion tapping tees, have found widespread use, particularly in connection with polymer or plastic mains used in Europe. These types of tapping tees typically include a plastic saddle that has a saddle surface with a curvature complementary to the curvature of the external surface of the pipe main. An electrically conductive heating coil can be embedded in the saddle for simultaneously heating the saddle surface and the pipe main external surface to fuse the saddle to the pipe main. A principle drawback in use of electrofusion is the fact that considerable operator skill and caution are required to prepare the pipe main surface. If this surface is contaminated the fused joint between the saddle and the pipe main may eventually fail and upon failure may produce considerable fluid leakage requiring extensive repairs (and interrupting service provided by the main, interruption that the use of a tapping tee is supposed to prevent).

Split collar tapping tees also find wide use, particularly in connection with polymer or plastic gas mains used extensively throughout the United States. These types of tapping tees, sometimes referred to generally as mechanical tapping tees, are typically held together by a suitable fastening arrangement, such as interconnecting bolts. One exemplary mechanical tapping tee for use in connecting a service line to a main is disclosed in commonly owned U.S. Pat. No. 4,809,735, which is expressly incorporated herein by reference. In particular, the '735 patent discloses a tapping tee assembly including a surrounding saddle or support assembly that is received around the main conduit. A generally cylindrical body is integrally formed with the support assembly and receives a tapping assembly therein. An internally threaded passage extends through the body and is generally perpendicular to the longitudinal axis of the main line. The tapping assembly further includes a cutter member that is selectively threadedly advanced through a sidewall of the main conduit, forming an opening as it is rotated through the sidewall.

In particular, a spreading or tapered portion of the cutter member advances through the opening to firmly grip the inner wall of the main conduit when properly positioned in place. An elongated portion of the cutter member remains within the main conduit, generally radially inward of the tapered portion. An upper portion of the tapping assembly is subsequently threadedly retracted from the cutter member to establish fluid communication from the main line, through apertures provided in the cutter member, and to a branch or service line connected to the body. The '735 patent also discloses a second embodiment wherein a two-part cutter is again used, but is modified so that material cut from the sidewall of the main conduit, or coupon as it is generally referred to, is removed from the interior of the main conduit. In most other respects, this modified embodiment works in much the same way to establish a fluid passage from the main conduit to a branch passage or service line.

Another exemplary mechanical tapping tee for use in connecting a service line to a main is disclosed in commonly owned U.S. Pat. No. 5,425,395, which is also expressly incorporated herein by reference. In particular, the '395 patent discloses a tapping tee assembly including a body member having an internal passage that receives a tapping apparatus comprised of a cutter having a cutting edge at one end thereof and a sleeve received over the cutter. The cutter has external threads which enable the tapping apparatus to be advanced to form an opening in a sidewall of the main about which the body member is secured. A retainer member, such as an o-ring, can be used to hold the sleeve and cutter together, particularly during advancement of the tapping apparatus, and the sleeve can include external threads that grip into the main's sidewall.

After forming the sidewall opening and threadedly engaging the sleeve with the sidewall, retraction of the cutter leaves the sleeve in place to secure the tapping apparatus to the main and establish fluid communication therethrough. The external threads of the cutter and sleeve preferably have different thread pitches so that the sleeve advances at a slightly faster rate than the cutter to facilitate sealing engagement between the main and the body member. A one-way drive arrangement is advantageously provided between the sleeve and cutter so that once the sleeve is positioned in the main, the cutter can be removed without altering the location of the sleeve. An O-ring can be provided annularly about and radially spaced from the sleeve to sealingly engage around the opening formed by the cutter through the sidewall of the main.

The mechanical tapping tees of the '735 and '395 patents have been commercially successful and are able to provide a leakproof seal with the mains to which the tapping tees are connected in both gas and water applications. While ably providing leakproof sealing with their respective mains, both upon initial installation and over time (e.g., the service life of the main), these types of mechanical tapping tees sometimes have difficulty passing a particular test of the German Technical and Scientific Association for Gas and Water (DVGW). The test, referred to as the DVGW-VP 304 test, is required for tapping tees to be certified by DVGW and only DVGW certified tapping tees are legally able to be installed on gas mains within Germany. While required for tapping tees to be used in gas pipelines in Germany, DVGW certification can also be advantageous for the commercial success of a tapping tee outside of Germany, particularly in nearby European countries where familiarity with DVGW certification is more common. In particular, others may view a DVGW certified tapping tee as being superior to noncertified tapping tees and thus be more likely to purchase and/or install such tapping tees.

Both mechanical and electrofusion tapping tees are subjected to the DVGW-VP 304 test and must pass before certification is granted. In one segment of the test, the tapping tee is tested in 80° Celsius. water. More particularly, to conduct this segment of the test, the tapping tee being tested is first secured to a simulated gas main. In the case of an electrofusion tapping tee, the tapping tee's saddle is fused with the main as described hereinabove. In the case of a mechanical tapping tee, the tapping tee's support assembly or body member is received about the main and, where the body member or support assembly is formed of two or more components, the components can be secured together using suitable fasteners. The tapping tee and gas main are then fully immersed in very hot water (e.g., 80° Celsius.). While submersed, and without tapping the main, the tapping tee is subjected for an extended period of time (e.g., about 165 hours) to a threshold pressure amount of pressurized gas (e.g., 10.8 bar) through its branch structure, which is typically used for connecting to a secondary conduit, purportedly for testing the connection between the tapping tee and the conduit for any leaks.

Heretofore, electrofusion tapping tees were the almost exclusive type of tapping tee used within Germany and it is believed that the DVGW-VP 304 test was developed particularly for electrofusion-type tapping tees (i.e., the tapping tees more commonly used throughout Germany). When applied to an electrofusion tapping tee, the integrity of the fused joint connecting the tapping tee to the water main is arguably confirmed by the test. In contrast, the test is not appropriate for mechanical tapping tees and arguably has no bearing on confirming the integrity of the seal created between a mechanical tapping tee and a main conduit when deployed in actual use in the field. The hot water of the test tends to disrupt the sealed connection between the mechanical tapping tee and the simulated main conduit. However, it is believed that such disruption would not occur after tapping of a main with a sleeve-type cutter as disclosed in the afore-referenced '395 patent because the threaded engagement of the sleeve with the main conduit would act as a seal between the tapping tee and the main conduit (a seal that would not be adversely affected by submersion in eighty degree Celsius water).

Nonetheless, while the test may be more suitable and appropriate for electrofusion tapping tees, mechanical tapping tees must be able to pass the test before certification will be granted, with certification being a prerequisite for entry into the German market and use in German gas pipeline systems. Accordingly, there is a need for a mechanical tapping tee that can overcome the drawbacks suffered by prior art mechanical tapping tees, including being able to pass the DVGW-VP 304 test.

### SUMMARY

According to one aspect, a mechanical tapping tee assembly is provided for fluidly connecting to a conduit. More particularly, in accordance with this aspect, the assembly includes a body defining a conduit recess for receiving the conduit in close relation relative to the body and further defining a main passage having one end adjacent the conduit recess. The main passage extends from the one end outwardly away from the recess. A plug is disposed in the main passage to prevent fluid communication between at least a portion of the main passage and the conduit recess. A threaded cutter is received in the main passage and threadedly engaged with a threaded region of the main passage for selective advancement and retraction within the main passage upon rotation relative to the body. The cutter includes a cutting edge for cutting through the plug and establishing fluid communication between the main passage and the conduit recess in which the conduit is received and further cutting through a side wall of the conduit to establish fluid communication between the main passage and the conduit.

According to another aspect, a method for tapping a conduit with a tapping tee assembly is provided. More particularly, in accordance with this aspect, a tapping tee assembly is provided that includes a body defining a conduit recess for receiving the conduit and further defining a main passage having one end adjacent the conduit recess. The tapping tee assembly further includes a plug disposed in the main passage preventing fluid communication between at least a portion of the main passage and the conduit recess. The body of the tapping tee assembly is secured to the conduit with the conduit received in the conduit recess. A cutter is advanced along the main passage toward the plug and toward the conduit. The plug is tapped with the cutter to fluidly connect the conduit recess and said at least a portion of the main passage previously prevented from fluidly communicating with the conduit recess. The conduit is tapped with the cutter to fluidly connect the conduit and the main passage.

According to yet another aspect, a leakproof tapping tee assembly is provided for tapping into a conduit to establish fluid communication between the conduit and another, secondary conduit. More particularly, in accordance with this aspect, the leakproof tapping tee assembly includes a body including one or more saddle sections defining a conduit recess for receiving the conduit in close cooperating relation. The body defines a main passage extending from adjacent the conduit recess outwardly away from the conduit. A plug is disposed in the main passage to prevent fluid communication between at least a portion of the main passage and the conduit recess. An externally threaded cutter is received in the main passage and is threadedly engaged with a threaded region of the main passage for selective advancement and retraction within the main passage upon rotation of the cutter relative to the body. The cutter includes a cutting edge for cutting through the plug and establishing fluid communication between the conduit and said at least a portion of the main passage, and further cutting through a side wall of the conduit to establish fluid communication between the main passage and the conduit.

### BRIEF DESCRIPTION OF THE DRAWINGS

FIG. 1 is a cross-sectional view an improved tapping tee assembly secured to a main conduit.

FIG. 2 is an enlarged view (in partial cross section) of the separate components that cooperate to define a tapping assembly of the tapping tee assembly of FIG. 1.

FIG. 3 is a cross-sectional view of the tapping tee assembly and main conduit of FIG. 1 shown after punching of a tower plug of the tapping tee assembly and prior to punching of the main conduit.

FIG. 4 is a cross-sectional view of the tapping tee assembly and main conduit of FIG. 1 shown with a tower plug coupon retracted after punching of the tower plug and prior to punching of the main conduit.

FIG. 5 is a cross-sectional view of the tapping tee assembly and main conduit of FIG. 1 shown after punching of the tower plug and the main conduit.

FIG. 6 is a cross-sectional view of the tapping tee assembly and main conduit of FIG. 1 shown with the tower plug coupon and a main conduit coupon retracted after punching of the tower plug and the main conduit wherein fluid communication is established with the main conduit.

### DETAILED DESCRIPTION

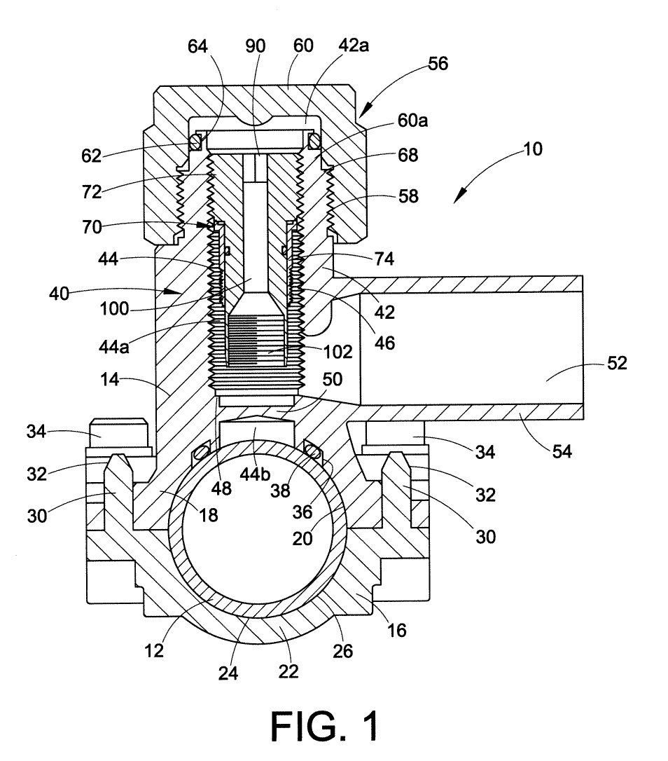

Referring now to the drawings wherein the showings are for purposes of illustrating one or more exemplary embodiments, the FIGURES show a method and apparatus for tapping an associated tubular or pipe-like member such as a gas or water main or the like. More particularly, and with particular reference to FIG. 1, a mechanical tapping tee assembly 10 for fluidly connecting to a conduit includes a body that can be securely clamped to an associated tubular member or main 12 (e.g., a water or gas main). The tapping tee assembly 10 of the illustrated embodiment employs a split ring or collar arrangement that includes a first or upper clamp portion 14 and a second or lower clamp portion 16, which together form the body. The upper clamp portion 14 includes an arcuate saddle section 18 having a generally semi-cylindrical inner surface 20, also referred to herein as a curvilinear recess or area, adapted to closely receive or conform to a portion of the cylindrical outer surface of the tubular member or main conduit 12. In the illustrated arrangement, the inner surface 20 is configured to cover approximately one-half the circumference of the main conduit 12 along a limited axial extent of the main conduit.

Similarly, lower portion 16 has an arcuate saddle section 22 having an inner, semi-cylindrical surface 24, also referred to herein as a curvilinear recess or area, adapted to closely receive or conform to a portion of the outer circumferential surface of the tubular member 12. The illustrated surface 24 is, like the surface 20, configured to cover approximately one-half the total circumference of the main conduit 12 along a limited axial extent thereof. By the surfaces 20,24, the body 12,14 defines a conduit recess 26 that is configured to receive the conduit 12 in close relation relative to the body (i.e., the surfaces 20,24 and the conduit outer surface are complementary to one another). In particular, the surfaces 20,24 of the illustrated embodiment form a circumferentially continuous surface that surrounds the conduit 12 when received in the conduit recess 26.

A fastening arrangement is used to secure the first and second body portions 14,16 together and provide clamping engagement about the outer surface of the conduit 12 when the conduit is disposed in the conduit recess 26 between the portions 14,16. In the illustrated embodiment, the fastening arrangement includes a plurality of fastening structures 30 formed integrally with the lower clamp portion 16 that extend upwardly through corresponding tapered apertures 32 defined in the upper clamp portion 14. Alternately, the structures 30 could be integrally formed with the upper clamp portion 14 and received through apertures defined in the lower clamp portion 16. In either case, caps 34 can be threadedly received on a distal end (not shown) of each fastening structure 30 that extends through its corresponding aperture 32. Tightening of the caps 34 on the threaded distal ends of the corresponding fastening structures 30 securely clamps the body (i.e., formed of the upper and lower clamp portions 14,16), and thus the tapping tee assembly 10, about the circumference of the tubular main conduit 12.

Of course, the fastening arrangement need not be as shown and described in reference to the illustrated embodiment. For example, the fastening arrangement could be a plurality of individual fasteners (i.e., not integrally formed with the body) received through aligned apertures provided in both the upper and lower clamp portions 14,16. One or both of a particular set of aligned apertures could be threaded to threadedly engage with the fastener received therethrough or, alternately, a threaded member (e.g., a nut) could simply be received threadedly on one end of the fastener with a fastener head provided on the opposite end. The fastening arrangement need only be sufficient to clamp onto the conduit 12 to allow a leakfree connection after tapping of the conduit.

To assist in providing a leakfree connection, the first body portion 14 includes an annular recess 36 defined in the surface 20. A seal 38, such as an o-ring seal, is received in the recess 36 for sealing engagement with the main conduit 12, particularly after the fastening arrangement is used to secure the body 14,16 of the tapping tee assembly to the main conduit 12. In particular, in the illustrated embodiment, the inner surface 20 of the arcuate saddle section 18 defines the annular recess 36 in which the seal 38 is received for sealing between the body 12,14 and the conduit 12 when the clamping portions 14,16 are secured together and clamped onto the conduit 12. As described in further detail below, the annular recess 36 and the seal 38 are located on the inner surface 20 so as to be annularly disposed about a location at which the cutter cuts through a sidewall of the conduit 12.

In the illustrated embodiment, the body 14,16 includes a tapping tee tower 40 that extends away from the conduit recess 26. As shown, the tower is included on and formed integrally with the upper clamp portion 14. The illustrated tower 40 includes a first member or branch 42 that extends approximately normally outward relative to a longitudinal axis of the main conduit 12 when the tapping tee assembly 10 is installed on the main conduit. The branch 42 can have a generally cylindrical configuration, although other configurations could be used with equal success. The body 14,16 has a first or main passage 44 defined therein. In particular, the passage 44 has one end adjacent the conduit recess 26 and extends outwardly away from the recess 26 through the tower 40, and particularly through the branch 42 in the illustrated embodiment. In addition, the passage 44 includes an internal threaded portion 46 extending axially over at least a portion of an axial extent of the passage 44. The main passage 44 is generally aligned with the annular recess 36 such that the recess is positioned radially outwardly relative to the main passage. An internal shoulder 48 is provided in the main passage 44 for reasons which will become more apparent below.

A tower plug 50, which can be formed integrally with the tower 40, is disposed within the main passage 44 to prevent fluid communication between at least a portion of the main passage 44 and the conduit recess 26. In the illustrated embodiment, the plug 50 bifurcates or segregates the main passage 44 into a first main passage portion 44a and a second main passage portion 44b. While in position, the tower plug 50 prevents fluid communication between the portions 44a,44b and more generally between at least a portion of the main passage 44 (i.e., the first or upper portion 44a in the illustrated embodiment) and the conduit recess 26. In particular, the plug 50 of the illustrated embodiment is spaced apart from the conduit recess 26 thereby defining the second or lower portion 44b of the main passage. In this arrangement, the first portion 44a is spaced apart from the conduit recess 26 and the second portion 44b is disposed adjacent and fluidly connected to the conduit recess 26.

As will be appreciated and understood by those skilled in the art, the upper and lower clamp portions 14,16 can both be formed of a polymer or plastic material, as can the conduit 12 onto which the portions 14,16 are secured. In the illustrated embodiment, the integral fastening structures 30 are formed of the same material as the lower clamp portion 16, however this is not required. For example, the fastening structures 30 could be stainless steel threaded inserts that are molded in the lower portion 16. Whether formed integrally with the clamp portion 14 or separately, the plug 50 can also be formed of a polymer or plastic. The main passage portions 44a,44b can be formed conventionally. For example, bores can be drilled from opposite ends (one end being adjacent the inner surface 20 and the opposite end being adjacent the groove 64) of the upper clamp portion 14. Such drilled bores can be bored to a desired depth, such as shown in the illustrated embodiment, to leave in place a portion of the body which functions as the tower plug 50 to prevent fluid communication between the main passage portions 44a,44b. Of course, other means of providing the tower plug 50 can be employed and should be considered as falling within the scope of the present disclosure. For example, a separate component could be installed within the main passage 44 to create the separate portions 44a,44b provided the separate component seals and prevents fluid communication between the portions 44a,44b or at least between the main passage 44 and conduit recess 26.

Communicating with the main passage 44 is a second or branch passage 52, which is defined by the tower 40 and particularly by a second generally cylindrical member or branch 54. In the illustrated embodiment, the branch 54 extends from the first branch 42 in a direction orthogonally oriented relative to a plane defined by an axis of the first branch 42 and the longitudinal axis of the main conduit 12. The branch passage 52 is fluidly connected to the main passage 44 for fluidly connecting to another component. More specifically, the branch passage 52 is fluidly connected to the portion of the main passage 44 (i.e., portion 44a in the illustrated embodiment) that is prevented from fluidly communicating with the conduit recess 26 by the plug 50. The branch passage 52 is adapted for communication with a service line or other individual hookup (not shown), details of which are well known in the art and require no further description herein. Preferably, the branch 54 is also integrally formed with the second body portion 16 so that it can be installed with the tower 40 in a single structure. Alternatively, separate components can be used although they may not be as conducive to ease of assembly and installation.

The tapping tee assembly 10 of the illustrated embodiment further includes a cap assembly 56 for selectively and sealingly closing an upper, open end of the main passage 44 opposite the end adjacent the conduit recess 26. More particularly, the tower 40 of the illustrated embodiment includes an exterior threaded region 58 adjacent an upper end 42a of the first branch for threadedly receiving a cap 60 thereon. A seal, such as o-ring seal 62, can also be provided as part of the cap assembly 56 and when provided is disposed within a circumferential groove 64 defined in the branch 42 axially between the upper end 42a and the threaded region 58. The seal 62 cooperates with an inner bore wall 60a of the cap to prevent any fluid from passing thereby.

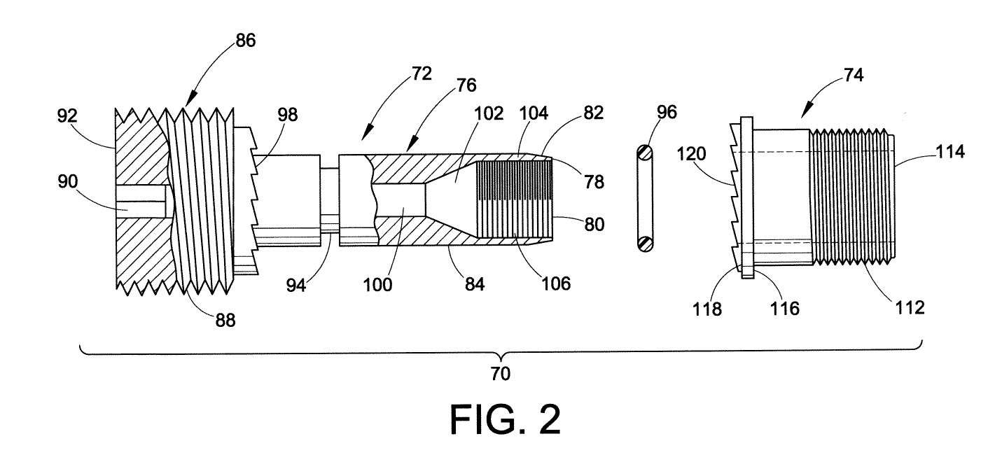

With additional reference to FIG. 2, the tapping tee assembly 10 also includes a tapping apparatus 70 comprising a first component or cutter 72 and a second component or sleeve 74. The cutter 72 includes a first radial portion 76 having an annular cutting edge 78 provided at a first end 80. The cutting edge 78 can be partially defined by a circumferential taper 82 provided at the first end 80 in an exterior surface 84 of the first radial portion 76. As will be described in more detail below, the cutting edge 78 is dimensioned or configured for cutting through the plug 50 and establishing fluid communication between the portion 44a of the main passage 44 and the conduit recess 26 in which the conduit 12 is received and further cutting through a side wall of the conduit 12 to establish fluid communication between the portion 44a of the main passage and the conduit 12. Cutting through a sidewall of the main conduit 12 ultimately establishes fluid communication between the main conduit and the branch passages 44,52 so that fluid in the main conduit can be provided to a service line attached to the second branch 54.

The cutter 72 further includes a second radial portion 86 having an externally threaded region 88. In particular, the threaded cutter 72 and the sleeve 74 are received in the main passage 44 when the tapping tee assembly 10 is fully assembled. The threaded cutter 72 is threadedly engaged with the threaded region 88 of the main passage 44 for selective advancement and retraction within the main passage 44 upon rotation relative to the body 14,16. The threaded region 88 has a first preselected thread pitch that cooperates with the internally threaded portion 46 of the main passage 44. Upon rotation of the threaded cutter 72 relative to the body 14,16, the cutter is either axially advanced or retracted from the main conduit 12 depending on the direction of rotation. A tool receiving recess 90, such as a hex-shaped tool socket that receives an appropriate tool (not shown) to effect the rotation of the cutter, is defined in a second end 92. Interposed between the first and second ends 80,92, a circumferential groove 94 is defined in the exterior surface 84 of the first radial portion 76. The groove 94 receives a resilient member 96, such as an o-ring, which is adapted for providing an interference, sealing fit with the sleeve 74. One purpose of the o-ring 96 is to at least temporarily retain the sleeve 74 and cutter 72 together in an initial assembled state, particularly when the sleeve and cutter are handled externally of the tower 40, but permit relative movement when the cutter 72 is advanced and retracted within the tower. The second radial portion 86 also includes a first ratchet region or element 98 that provides for selective driving between the cutter and the sleeve as described in more detail below.

In the illustrated embodiment, a fluid communication passage 100 extends axially through the cutter 72 from the first end 80 to the second end 92. In this embodiment, the tool receiving recess 90 is but a portion of the passage 100 that is adjacent the second end 92. Adjacent the first end 80, a portion 102 of the passage 100 diametrically expands to form a thinned wall section 104 which, together with the taper 82, defines the cutting edge 78. As will be described below in more detail, the diametrically expanded portion or recess 102 is adapted to, and axially sized to, receive cutout portions or coupons created by the cutting edge 78. Internal threads 106 can be provided along the portion 102 extending radially inwardly from the thinned wall section 104 for retaining coupons received within the recess or portion 102. In particular, the cutter recess 102 is configured to retain a plug coupon 126 from the plug 50 after the cutter 72 cuts through the plug 50 and is retracted from the plug, and is further configured to retain a conduit coupon 130 from the conduit 12 in addition to the plug coupon.

The sleeve 74 is a generally tubular or hollow cylindrical member having external threads 112 extending axially inwardly from a first end 114 and a radially extending shoulder 116 at or adjacent a second end 118. When the tapping apparatus 70 is fully assembled, the sleeve 74 is received around the cutter 72. The sleeve 74 is dimensioned for close receipt around the cutter 72 and forms an interference fit therewith via the o-ring 96. The threads 112 advance into and threadedly grip the sidewall of the main conduit 12 after the cutting edge 78 of the cutter 72 has removed a portion of the main conduit sidewall, typically referred to as a “coupon” (i.e., the conduit coupon 130). The threads 112 can extend axially along the sleeve 74 a dimension sufficient to engage along the entire depth of the sidewall.

A second cooperating ratchet region or element 120 is provided at the second end 118 of the sleeve 74. The ratchet element 98 of the cutter 72 and ratchet element 120 of the sleeve 74 are each defined by a series of sloped or ramped shoulders. The ramped shoulders are circumferentially spaced apart and provide for a one-way driving engagement between the cutter 72 and sleeve 74. Thus, as the cutter is advanced by an associated tool, the ratchet elements 98,120 cooperate (i.e., the sloped shoulders engage) with one another to provide driving rotatable and axial movement to the sleeve 74 as the cutter 72 is rotated in a first direction (e.g., advancing direction relative to the main conduit 12). Rotation of the cutter 72 in a second, opposite direction (e.g., retracting relative to the main conduit 12) allows the tapered surfaces to slide one over the other and thus no axial movement is imparted to the sleeve by the cutter. As will be appreciated and understood by those skilled in the art, other driving arrangements can be used with the illustrated tapping tee assembly 10, including other one-way driving arrangements. For example, rather than sloped shoulders, opposed continuous helical edges can be provided on the cutter and the sleeve as shown and described in the afore-referenced '395 patent.

The external threads 112 on the sleeve 74 can have a second preselected thread pitch that is different or varies from the thread pitch on the threads 88 of the cutter 72. Specifically, a greater number of threads per inch can be provided on the cutter 72 than on the sleeve 74. By way of example only, the thread pitch on the cutter 72 can be eight threads per inch while the thread pitch on the sleeve 74 can be approximately six threads per inch. This relationship requires a lesser number of turns to advance the sleeve 74 a predetermined distance than are required to axially advance the cutter 72 the same distance or dimension.

It is expected that the illustrated tapping tee assembly 10 will pass the DVGW-VP 304 test, particularly the segment of the test that tests the tapping tee in 80° Celsius. water with the tapping tee assembly secured to a simulated main conduit prior to tapping of the conduit. The tower plug 50 of the illustrated tapping tee assembly 10 will serve to prevent any leaks from occurring during immersion in the eighty degree Celsius water and while the threshold pressure amount of fluid (e.g., pressurized gas) is sent through the branch passage 52 and into the main passage 44 (particularly, the first main passage portion 44a). There can be no leaks in the connection between the tower 40 and a simulated conduit because no fluid entering through the branch passage 52 is able to pass by the tower plug 50 and into the second main passage portion 44b, which is disposed adjacent any conduit to which the tapping tee assembly is connected.

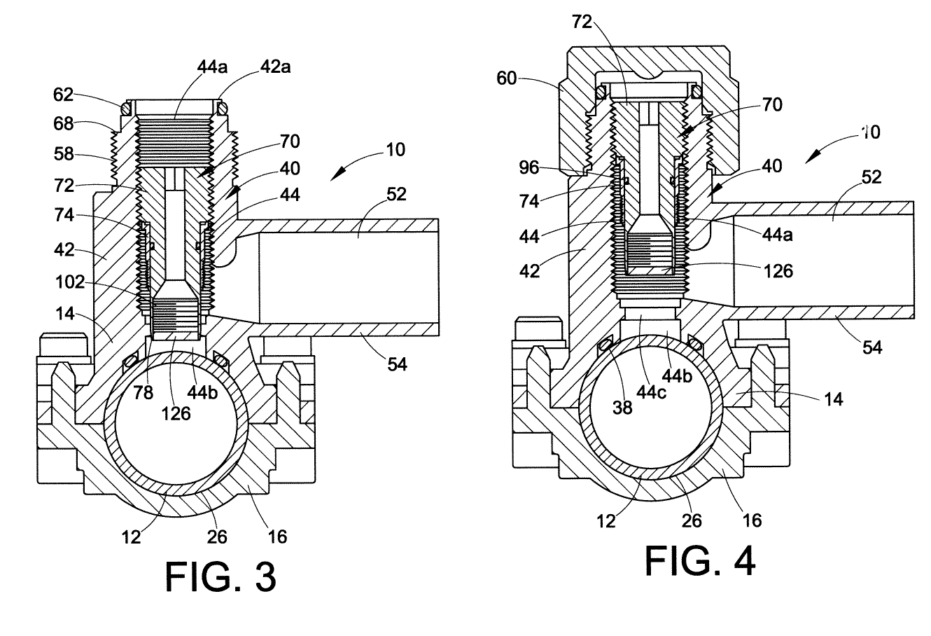

Operation of the tapping tee assembly 10, and a method for tapping the main conduit 12 with the tapping tee assembly 10, will be described hereafter with further reference to FIGS. 3-6. The body 14,16 of the tapping tee assembly 10 is secured to the conduit 12 with the conduit received in the conduit recess 26. In particular, the saddle sections 18,22 are positioned about the circumference of the main conduit 12 and the upper and lower clamp portions 14,16 are secured to one another using the fastening arrangement including the fastening structures 30 and the caps 34. Once the tapping tee assembly 10 is secured to the main conduit 12 (as shown in FIG. 1), the cap 60 can be removed from the tapping tee tower 40.

The assembled tapping apparatus 70 can be predisposed in the main passage 44, particularly the upper portion 44a of the main passage, or may at this time be placed therein. As shown in FIG. 3, the annular cutting edge 78 of the cutter 72 can be advanced along the main passage 44 toward the tower plug and toward the main conduit 12 by means of the threaded engagement between the cutter 72 and the threaded portion 46 of the main passage 44. More specifically, a conventional tool imparts a rotational force on the cutter 72 in a first direction with respect to the branch 42 to advance the cutter toward the main conduit 12. Continued rotation of the cutter 72 causes it to tap or cut through the tower plug 50 and thereby form the passage 44 as a continuous passage (portion 44a is fluidly connected to portion 44b via cut passage portion 44c). Upon complete cutting through of the tower plug, the conduit recess 26 is fluidly connected to the portion 44a previously prevented from fluidly communicating with the conduit recess 26 and the tower plug or coupon 126 is retained within the cutter 72. Specifically, the coupon 126 is received within the cutter recess 102 (i.e., the diametrically expanded portion of the cutter passage 100) and retention therein is facilitated by the internal threads 106.

With the tower plug coupon 126 retained in the cutter 72, the cutter 72 can be rotated in a second, reverse direction to retract the cutter along the main passage 44 away from the main conduit 12. The sleeve 74 will tend to retract with the cutter 72 due to o-ring 96 arranged radially between the cutter and the sleeve and no sufficient force overcoming the frictional engagement of the o-ring 96 with the sleeve 74. With the tower plug 50 removed (or at least the tower plug coupon 126 removed from the tower plug to permit fluid communication therethrough) and the cutter 72 retracted (as shown in FIG. 4), fluid communication can be established between the main passage portion 44b and the branch passage 52. At this point, the cap 60 can be reinstalled on the tower 40 to seal the main passage 44 and a conventional leak test (not the DVGW-VP 304 test) can be conducted on the tapping tee assembly 10. The conventional leak test is typically performed in the field with a service line already connected to the second branch 54. To conduct the test, a pressurized fluid (e.g., pressurized water or gas) is directed through the service line and into the tapping tee assembly 10. (There would be no submission in eighty degree Celsius water during such a field test). Specifically, the pressurized fluid from the service line enters the second branch passage 52 and then the main passage 44. In the case of the main conduit 12 being a water main, a visual inspection of the tapping tee assembly 10 can then be conducted to determine if any of the fluid entering the main passage 44 is escaping and leaking (e.g., by the seal 38 between the upper clamp portion 14 and the main conduit 12 or through the connection of the cap 60 and the tower 40).

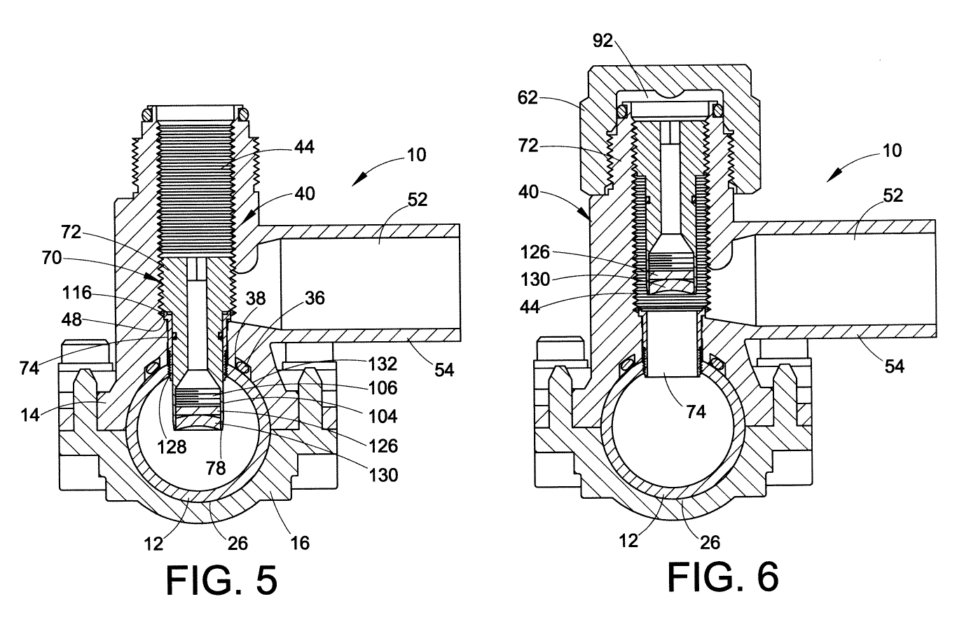

Provided no leaks are discovered during the conventional leak test, with particular reference to FIG. 5, the cap 60 can again be removed and the cutter 72 and its cutting edge 78 can again be rotated in the first direction to again advance the cutter 72 and the sleeve 74 toward the main conduit 12. Continued rotation and advancement by the cutter 72 ultimately causes it to tap or cut through the conduit 12 to form an aperture 128 through the sidewall of the main conduit 12. Upon completion of the main conduit cutting process, the conduit 12 is fluidly connected to the main passage 44 and a second cut plug or coupon 130, this one being a piece removed from the main conduit 12, is circumferentially retained within the cutter recess 102 with the threads 106 facilitating such retention. The second plug 130 displaces the tower plug 126 further into the cutter 72 such that both coupons 126,130 are fully retained within the recess 102 and not easily removed due to the tendency of the threads 106 to threadedly engage with the coupons.

Still further continued rotation and advancement of the cutter 72 then causes the sleeve 74 to forcibly enter the conduit 12. In particular, the sleeve 74 has a diameter that slightly exceeds a diameter of the main conduit aperture 128. As expected, the diameter of the main conduit aperture 128 generally matches the cutter 72, particularly the lower radial portion 76 of the cutter. Due to the sleeve's slightly larger diameter and its threads 112, the sleeve 74 threadedly engages with the sidewall of the conduit 12 via the sleeve's threads 112 as the sleeve is forcibly advanced into the conduit by the cutter 72. This threaded relationship ensures a leakproof connection between the sleeve 74 and the conduit 12 (i.e., fluid is prevented from passing between the exterior threaded surface of the sleeve 74 and the conduit sidewall to which the sleeve is threadedly engaged).

During advancement of the sleeve 74, including forced advancement through the tower plug 50 and subsequent advancement through the sidewall of the main conduit 12, the sleeve 74 will have a tendency to advance at a faster rate than the cutter 72 due to the lower thread pitch of the sleeve threads 112 (i.e., more threads per inch) relative to the thread pitch of the cutter threads 88. Thus, as discussed more fully in the afore-referenced '395 patent, the sleeve 74 can become axially separated from the cutter 72 (i.e., the ratchet elements 98,120 can become separated) at selected stages of axial advancement of the tapping apparatus, particularly as the sleeve 72 begins to cut and threadedly engage the tower plug 50 and again when the sleeve 72 begins to cut and threadedly engage the main conduit 12.

One purpose of the differential threaded relationship between the cutter 72 and the sleeve 72 is to ensure that an external surface 132 of the conduit 12 is held in sealing engagement with the upper clamp portion 14 via the oaring 38 that now surrounds the main conduit aperture 128, particularly during advancement of the sleeve 74 into the conduit 12. The effect of the different thread pitches on the cutter 72 and the sleeve 74 is an urging or pulling of the main conduit 12 into tight sealing engagement with the upper clamp portion 14 (and the seal 38) during the advancement of the sleeve into the main conduit 23. Though the cutter 72 and sleeve 74 may become temporarily separated during axial advancement of the tapping apparatus 70, continued rotation and axial advancement of the cutter 72 toward the main conduit 12 ultimately results in cooperative engagement between the ratchet elements 98, 120 for continued rotation and axial movement of the sleeve 74 into the sidewall of the main conduit 12 as already described.

Axial advancement of the sleeve 74 is limited by the internal shoulder 48 of the tower 40. More particularly, the sleeve 74 can be advanced in the direction of the main conduit 12 until the sleeve shoulder 116 engages the internal shoulder 48. This provides a positive feedback to the user or installer that the sleeve 74 is fully in position and that the main conduit coupon 130 has been cut from the main conduit 12. Moreover, the shoulder 116 cooperates with the internal shoulder 48 in the tapping tower 40 to limit advancement of the sleeve first end 114 into the main conduit 12. In this way, only a minimal amount of the sleeve 74 extends into the fluid path defined by the main conduit 12. Still further, the sleeve 74 provides substantial resistance against pull out forces, i.e., forces directed along the longitudinal axis of the tower 40. In addition, the threaded sleeve 74 stabilizes the tapping assembly 70 against movement in a circumferential direction of the main conduit 12 and also along the longitudinal axis of the main conduit 12. This, in conjunction with the clamping arrangement provided by the clamp portions 14,16, secures the tapping tee assembly 10 along the main conduit 12.

If not already installed, associated piping can now be joined to the second branch 54 and then the cutter 72 can be retracted from the conduit 12 and separated from the sleeve 74. More particularly, and with reference to FIG. 6, after full installation of the sleeve 74 into the main conduit 12, the cutter 72 can be rotated in the opposite direction to axially retract it from the main conduit 12. The threaded engagement of the sleeve 74 and the conduit 12 is sufficient to overcome the frictional connection between the seal 96 and the sleeve such that retraction of the cutter leaves the sleeve in position in the conduit. The threaded retraction of the cutter 72 can continue until the terminal edge of the second end 92 of the cutter 72 is flush with the top of the tapping tower 40. By predetermined dimensioning, the installer is assured that fluid communication is now established between the main conduit 12, through the sleeve 74, through the main passage 44 of the tapping tower 40, and to the branch passage 52. Lastly, the cap 60 can be reinstalled on the tower 40.

As already described, the tapping tee assembly 10 of the illustrated embodiment provides a mechanical tapping tee assembly capable of providing a leakproof connection with an actual main conduit, including water mains and gas mains. As also already discussed, mechanical tapping tees generally, including the tapping tee assembly 10, also provide many advantages over conventional electrofusion tapping tees. In addition, the mechanical tapping tee assembly 10 of the illustrated embodiment advantageously provides a tapping tee that can pass the DVGW-VP 304 test.

The exemplary embodiment or embodiments have been described with reference to preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A mechanical tapping tee assembly for fluidly connecting to a conduit, the assembly comprising:
a body defining a conduit recess for receiving the conduit in close relation relative to the body and further defining a main passage having one end adjacent the conduit recess, the main passage extending from the one end outwardly away from the recess;
a plug disposed in the main passage to prevent fluid communication between at least a portion of the main passage and the conduit recess; and
a threaded cutter received in the main passage and threadedly engaged with a threaded region of the main passage for selective advancement and retraction within the main passage upon rotation relative to the body, the cutter including a cutting edge for cutting through the plug and establishing fluid communication between said at least a portion of the main passage and the conduit recess in which the conduit is received and further cutting through a sidewall of the conduit to establish fluid communication between said at least a portion of the main passage and the conduit.

2. The mechanical tapping tee assembly of claim 1 wherein the plug is spaced apart from the conduit recess so as to segregate the main passage into a first main passage portion spaced apart from the conduit recess and a second main passage portion disposed adjacent and fluidly connected to the conduit recess the first main passage portion being the at least a portion of the main passage prevented from fluidly communicating with the conduit recess by the plug.

3. The mechanical tapping tee assembly of claim 1 wherein the cutter includes a cutter recess configured to retain a plug coupon from the plug after the cutter cuts through the plug and is retracted from the plug, the cutter recess also configured to retain a conduit coupon from the conduit, in addition to the plug coupon, after the cutter cuts through the conduit and is retracted from the conduit.

4. The mechanical tapping tee of claim 1 wherein a sleeve is received around the cutter and includes external threads adapted to thread into a sidewall of the conduit after a conduit coupon of the conduit is removed and remain threadedly engaged with the conduit sidewall when the cutter is retracted with the conduit coupon.

5. The mechanical tapping tee assembly of claim 4 further including a one-way drive connection having an engaging surface between the sleeve and the cutter to selectively engage one another so that the sleeve is threaded into engagement with the sidewall and retained in place when the cutter is retracted in the body with the conduit coupon retained therein.

6. The mechanical tapping tee of claim 1 wherein the plug is integrally formed with the body.

7. The mechanical tapping tee of claim 6 wherein the body and the plug are formed of a polymer or plastic material.

8. The mechanical tapping tee of claim 1 further including:
a first clamp portion and a second clamp portion, which together form the body; each of the first and second clamp portions having an arcuate saddle section having a generally semi-cylindrical inner surface adapted to closely receive or conform to an outside surface of the conduit, the inner surface of each of the first and second clamp portions defines the conduit recess in which the conduit is received; and
a fastening arrangement for securing the first and second clamp portions to one another and for providing clamping engagement about the outer surface of the conduit when the conduit is disposed in the conduit recess between the first and second clamping portions.

9. The mechanical clamping tee of claim 8 wherein the fastening arrangement includes a plurality of fastening structures formed integrally with one of the first and second clamping portions that extend upwardly through corresponding tapered apertures defined in the other of the first and second clamping portions with caps threadedly received on distal portions of the fastening structures that extend through the corresponding tapered apertures to clamp the first and second portions onto the conduit.

10. The mechanical clamping tee of claim 8 wherein the inner surface of the arcuate saddle section of one of the first and second clamping portions defines an annular recess in which a seal is received for sealing between the body and the conduit when the first and second clamping portions are secured together and clamped onto the conduit, the annular recess and the seal being located on the inner surface so as to be annularly disposed about a location at which the cutter cuts through the sidewall of the conduit.

11. The mechanical tapping tee of claim 1 wherein the body includes a tapping tee tower that extends away from the conduit recess and has the main passage defined therein, the tapping tee tower defining a branch passage fluidly connected to the main passage for fluidly connecting to another component, the branch passage is fluidly connected to the at least a portion of the main passage that is prevented from fluidly communicating with the conduit recess by the plug.

12. The mechanical tapping tee of claim 1 further including a cap assembly for selectively and sealingly closing an upper, open end of the main passage opposite the one end adjacent the conduit recess.

13. A method for tapping a conduit with a tapping tee assembly, comprising:
providing a tapping tee assembly including a body defining a conduit recess for receiving the conduit and further defining a main passage having one end adjacent the conduit recess, the tapping tee assembly further including a plug disposed in the main passage preventing fluid communication between at least a portion of the main passage and the conduit recess;
securing the body of the tapping tee assembly to the conduit with the conduit received in the conduit recess;
advancing a cutter along the main passage toward the plug and toward the conduit;
tapping the plug with the cutter to fluidly connect the conduit recess and said at least a portion of the main passage previously prevented from fluidly communicating with the conduit recess; and
tapping the conduit with the cutter to fluidly connect the conduit and the main passage.

14. The method of claim 13 wherein the tapping tee assembly includes a first clamp portion and a second clamp portion, which together form the body, each of the first and second clamp portions having an arcuate saddle section having a generally semi-cylindrical inner surface adapted to closely receive or conform to an outside surface of the conduit, the inner surface of each of the first and second clamp portions defines the conduit recess, and wherein securing the body of the tapping tee assembly to the conduit includes positioning the saddle sections about the circumference of the conduit and securing the first and second clamp portions to one another for providing clamping engagement with the conduit.

15. The method of claim 13 wherein advancing the cutter along the main passage includes
providing an externally threaded cutter in the main passage and threadedly engaged with a threaded region of the main passage;
rotating the cutter in a first direction to advance the cutter toward the plug and the conduit by means of the threaded engagement between the cutter and the threaded region of the main passage.

16. The method of claim 15 further including:
retracting the cutter along the main passage away from the conduit after tapping the plug by rotating the cutter in a second opposite direction; and
again advancing the cutter along the main passage toward the conduit after retracting the cutter to tap the conduit and form an aperture through a sidewall of the conduit thereby establishing fluid communication between the conduit and the main passage; and
again retracting the cutter along the main passageway from the conduit to fully establish fluid communication between the conduit and the main passageway.

17. The method of claim 16 further including:
conducting a leak test on the tapping assembly after the cutter is retracted along the main passage way from the conduit;
determining whether a leak has occurred by performing a visual inspection to find any leaks; and
if determined that there are not leaks, then proceeding with again advancing the cutter along the main passage toward the conduit.

18. The method of claim 16 wherein the plug is integrally formed with the body and tapping the plug causes a plug coupon to be removed from the body, the plug coupon being retained by the cutter when the cutter is retracted along the main passageway, and wherein tapping the conduit causes a conduit coupon to be removed from the body, the conduit coupon and the plug coupon being retained by the cutter when the cutter is again retracted along the main passageway from the conduit.

19. The method of claim 16 wherein tapping the conduit with the cutter and again retracting the cutter include:
forcing a sleeve disposed about the cutter into the aperture of the conduit; and
retaining the sleeve in the aperture of the conduit when the cutter is again retracted along the main passageway.

20. A leakproof tapping tee assembly for tapping into a conduit to establish fluid communication between the conduit and another, secondary conduit, comprising:
a body including one or more saddle sections defining a conduit recess for receiving the conduit in close cooperating relation, the body defining a main passage extending from adjacent the conduit recess outwardly away from the conduit;
a plug disposed in the main passage to prevent fluid communication between at least a portion of the main passage and the conduit recess; and
an externally threaded cutter received in the main passage and threadedly engaged with a threaded region of the main passage for selective advancement and retraction within the main passage upon rotation of the cutter relative to the body, the cutter including a cutting edge for cutting though the plug and establishing fluid communication between the conduit and said at least a portion of the main passage and further cutting through a sidewall of the conduit to establish fluid communication between the main passage and the conduit.
